(19) United States
(12) Patent Application Publication
(10) Pub. No.: US 2026/0121711 A1
(43) Pub. Date: Apr. 30, 2026

(54) DIRECTIONAL COMMUNICATIONS FOR ANTENNA SUBARRAYS

(71) Applicant: QUALCOMM Incorporated, San Diego, CA (US)

(72) Inventors: Vasanthan RAGHAVAN, West Windsor Township, NJ (US); Ebraam Adel KHALIFA, Ottensoos (DE); Mustafa EMARA, Munich (DE); Valentin Alexandru GHEORGHIU, Yokohama-shi (JP); Marco PAPALEO, Bologna (IT)

(21) Appl. No.: 18/930,868

(22) Filed: Oct. 29, 2024

(51) Int. Cl. H04B 7/06; H04B 7/0452; H04W 56/00

(52) U.S. Cl. CPC H04B 7/0617; H04B 7/0452; H04W 56/0015

(57) ABSTRACT

Some examples of the techniques described herein may relate to multi-user multiple-input multiple-output (MU-MIMO) transmissions as a communications scheme for equivalent isotropic radiated power (EIRP) masks. For MU-MIMO transmissions, co-scheduled user equipments (UEs) may be separated in azimuth or elevation domains. Some approaches are provided in which UE separation or subarray architecture at a network may be incorporated in terms of EIRP masks. In some approaches, a wireless device (e.g., base station, transmission-reception point (TRP), or network entity, among other examples) may receive signals from UEs in different directions. An angular separation may be utilized to select a beamforming scheme (e.g., discrete Fourier transform (DFT) beamforming, zero-forcing beamforming, or inverse beamforming, among other examples). In some examples, transmit power may be controlled utilizing a power backoff scheme that may be selected based on the angular range or associated with a beamforming scheme.

### FIELD OF TECHNOLOGY

The following relates to wireless communications, including directional communications for antenna subarrays.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a wireless device is described. The method may include receiving a first signal from a first user equipment (UE), where the first signal is received from a first direction at the wireless device, receiving a second signal from a second UE, where the second signal is received from a second direction at the wireless device, and communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

A wireless device is described. The wireless device may include one or more memories storing processor executable code, and one or more processors coupled with the one or more memories. The one or more processors may individually or collectively be operable to execute the code to cause the wireless device to receive a first signal from a first UE, where the first signal is received from a first direction at the wireless device, receive a second signal from a second UE, where the second signal is received from a second direction at the wireless device, and communicate with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

Another wireless device is described. The wireless device may include means for receiving a first signal from a first UE, where the first signal is received from a first direction at the wireless device, means for receiving a second signal from a second UE, where the second signal is received from a second direction at the wireless device, and means for communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

A non-transitory computer-readable medium storing code is described. The code may include instructions executable by one or more processors to receive a first signal from a first UE, where the first signal is received from a first direction at the wireless device, receive a second signal from a second UE, where the second signal is received from a second direction at the wireless device, and communicate with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

In some examples of the method, wireless devices, and non-transitory computer-readable medium described herein, the first beamforming scheme includes discrete Fourier transform (DFT) codebook-based beamforming or beamforming with beam weights with a progressive phase shift applied to the first subarray of antennas or the second subarray of antennas.

In some examples of the method, wireless devices, and non-transitory computer-readable medium described herein, the second beamforming scheme includes zero-forcing beamforming or generalized inverse beamforming.

Some examples of the method, wireless devices, and non-transitory computer-readable medium described herein may further include operations, features, means, or instructions for selecting the first beamforming scheme or the second beamforming scheme based on a threshold, where the first beamforming scheme may be selected if the angular separation satisfies the threshold or the second beamforming scheme may be selected if the angular separation does not satisfy the threshold.

Some examples of the method, wireless devices, and non-transitory computer-readable medium described herein may further include operations, features, means, or instructions for receiving, from a network entity, configuration information indicating the threshold.

In some examples of the method, wireless devices, and non-transitory computer-readable medium described herein, the threshold may be a function of a first size of the first subarray, a second size of the second subarray, or a combination thereof.

In some examples of the method, wireless devices, and non-transitory computer-readable medium described herein, at least one of the first subarray or the second subarray in the first beamforming scheme may be respectively larger than at least one of the first subarray or the second subarray in the second beamforming scheme.

In some examples of the method, wireless devices, and non-transitory computer-readable medium described herein, the first power backoff scheme increases a degree of power backoff in association with an increased quantity of antennas of the first subarray or of the second subarray.

Some examples of the method, wireless devices, and non-transitory computer-readable medium described herein may further include operations, features, means, or instructions for transmitting a synchronization signal block (SSB) via the first beam or the second beam and receiving a signal indicating a characteristic of the SSB, where a degree of power backoff of the first power backoff scheme or of the second power backoff scheme may be based on the characteristic of the SSB.

In some examples of the method, wireless devices, and non-transitory computer-readable medium described herein, the first UE may be grouped in a first group of one or more UEs and the second UE may be grouped in a second group of one or more UEs to satisfy an effective isotropic radiated power (EIRP) limit over an angular range from the wireless device.

In some examples of the method, wireless devices, and non-transitory computer-readable medium described herein, the first group of one or more UEs and the second group of one or more UEs may be included in a multi-user multiple-input multiple-output (MU-MIMO) communication from the wireless device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports directional communications for antenna subarrays in accordance with one or more aspects of the present disclosure.

FIG. 2 shows an example of a network architecture that supports directional communications for antenna subarrays in accordance with one or more aspects of the present disclosure.

FIG. 3 shows an example of a wireless communications system that supports directional communications for antenna subarrays in accordance with one or more aspects of the present disclosure.

FIG. 4 shows a diagram illustrating examples of beamforming that support directional communications for antenna subarrays in accordance with one or more aspects of the present disclosure.

FIG. 5 shows a diagram illustrating examples of beamforming that support directional communications for antenna subarrays in accordance with one or more aspects of the present disclosure.

FIG. 6 shows an example of a process flow that supports directional communications for antenna subarrays in accordance with one or more aspects of the present disclosure.

FIGS. 7 and 8 show block diagrams of devices that support directional communications for antenna subarrays in accordance with one or more aspects of the present disclosure.

FIG. 9 shows a block diagram of a communications manager that supports directional communications for antenna subarrays in accordance with one or more aspects of the present disclosure.

FIG. 10 shows a diagram of a system including a device that supports directional communications for antenna subarrays in accordance with one or more aspects of the present disclosure.

FIGS. 11 and 12 show flowcharts illustrating methods that support directional communications for antenna subarrays in accordance with one or more aspects of the present disclosure.

### DETAILED DESCRIPTION

Some wireless communications systems produce or experience interference. For instance, a wireless communication signal produced by one wireless device may interfere with the communications of another wireless device. Some approaches to interference management or coexistence issues may be addressed based on an effective isotropic radiated power (EIRP) mask, which may be defined in terms of worst-case or average interference scenarios. An EIRP mask may provide a regulatory limitation on a quantity of transmit power that a wireless device is allowed to transmit in a direction or directional range. For transmissions over a range of elevation angles, for example, an EIRP mask may cap the interference experienced by satellites, drones, or other aerial objects (e.g., potential victim nodes of the interference). Some wireless devices may produce C-band transmissions (e.g., transmissions in a frequency range up to approximately 3.98 gigahertz (GHz)), which may create interference for radio altimeters that operate in the 4.2-4.4 GHz range. Other examples of interference may occur in other frequency ranges (e.g., frequency range 3 (FR3), 7.125-24.25 GHz, in the 7.125 to 8 GHz range, frequency range 2 (FR2), or intermediate frequencies of some FR2 services in FR3, among other examples).

One or more EIRP masks may be specified for one or more frequency ranges. For instance, FR3 may be utilized for various coexisting services, and EIRP mask definitions for such bands may be utilized to regulate transmissions for sixth generation (6G) wireless communications systems. Some aspects of FR3 transmissions or multi-panel transmissions may be considered for regulatory and compliance definitions (e.g., for EIRP mask definitions, which may be similar to, or may differ from, EIRP mask definitions for one or more other technologies or frequency ranges).

Some examples of the techniques described herein may relate to multi-user multiple-input multiple-output (MU-MIMO) transmissions as a communications scheme for EIRP masks. For instance, some examples may provide subarray architecture-driven EIRP mask considerations for MU-MIMO systems. For MU-MIMO transmissions, co-scheduled devices (e.g., user equipments (UEs)) may be separated in azimuth or elevation domains. Some examples of the techniques described may provide approaches in which UE separation or subarray architecture at a network (e.g., gNodeB (gNB)) may be incorporated in terms of EIRP masks.

In some approaches, a wireless device (e.g., base station, transmission-reception point (TRP), or network entity, among other examples) may receive signals from UEs in different directions. An angular separation (or angular range, for instance) may be utilized to select a beamforming scheme (e.g., discrete Fourier transform (DFT) beam weight-based beamforming, zero-forcing beamforming (e.g., regularized zero-forcing beamforming), or inverse-based beamforming (e.g., generalized inverse-based beamforming), among other examples). In some examples, transmit power may be controlled utilizing a power backoff scheme that may be selected based on the angular range or associated with a beamforming scheme.

In some examples, utilizing an angular separation for selecting a beamforming scheme may provide adaptability to differing network conditions. For instance, greater directional gain may be provided to UEs if there is an amount of (e.g., sufficient) angular separation between UEs, or interference may be avoided between beams to UEs if there is less than the amount of angular separation between UEs.

In some aspects, selecting a power backoff scheme based on the angular separation or in association with the beamforming scheme may help to reduce or avoid interference. For instance, some beamforming schemes may provide greater directional gain that may also provide increased interference via one or more sidelobes. Controlling the transmit power based on the angular separation or selected beamforming scheme may reduce interference caused to one or more victim nodes located in another direction relative to the wireless device. Additionally, or alternatively, controlling the transmit power based on the angular separation or selected beamforming scheme may allow MU-MIMO transmissions via multiple beams while reducing or avoiding interference in one or more directions relative to the wireless device.

Aspects of the disclosure are described in the context of wireless communications systems. Aspects of the disclosure are also described in the context of a network architecture and diagrams illustrating examples of beamforming. Aspects of the disclosure are further illustrated by and described with reference to apparatus diagrams, system diagrams, and flowcharts that relate to directional communications for antenna subarrays.

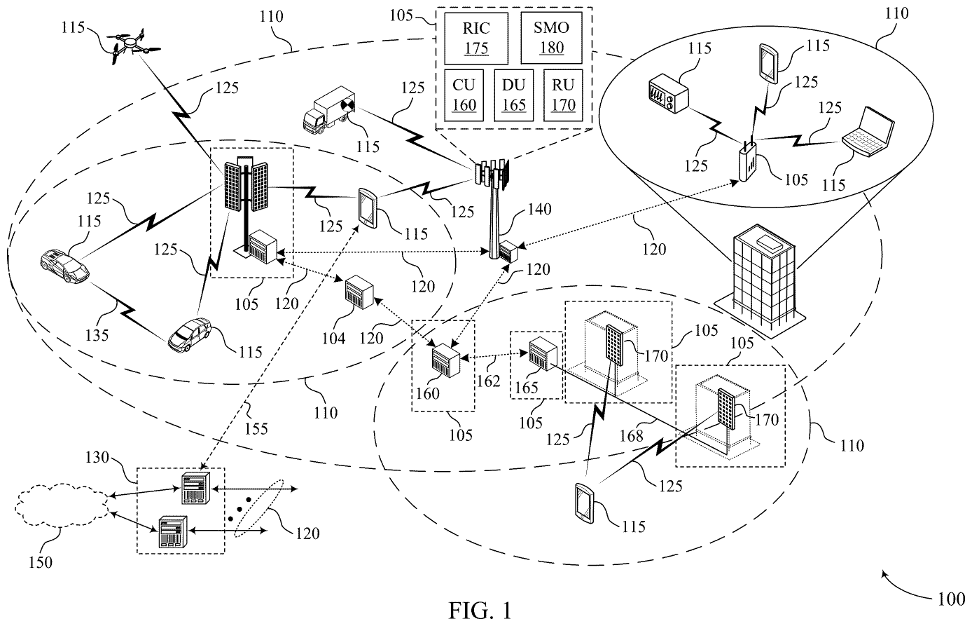

FIG. 1 shows an example of a wireless communications system 100 that supports directional communications for antenna subarrays in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support directional communications for antenna subarrays as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported DFT size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems produce or experience interference. For instance, a wireless communication signal produced by one wireless device may interfere with the communications of another wireless device. Some approaches to interference management or coexistence issues may be addressed based on an EIRP mask, which may be defined in terms of worst-case or average interference scenarios. An EIRP mask may provide a regulatory limitation on a quantity of transmit power that a wireless device is allowed to transmit in a direction or directional range. For transmissions over a range of elevations, for example, an EIRP mask may cap the interference experienced by satellites, drones, or other aerial objects (e.g., potential victim nodes of the interference). Some wireless devices may produce C-band transmissions (e.g., transmissions in a frequency range up to approximately 3.98 GHz), which may create interference for radio altimeters that operate in the 4.2-4.4 GHz range. Other examples of interference may occur in other frequency ranges (e.g., FR3, 7.125-24.25 GHz, U6 GHz, FR2, or intermediate frequencies of some FR2 services in FR3, among other examples).

One or more EIRP masks may be specified for one or more frequency ranges. For instance, FR3 may be utilized for various coexisting services, and EIRP mask definitions for such bands may be utilized to regulate transmissions for 6G wireless communications systems. Some aspects of FR3 transmissions or multi-panel transmissions may be considered for regulatory and compliance definitions (e.g., for EIRP mask definitions, which may be similar to, or may differ from, EIRP mask definitions for one or more other technologies or frequency ranges). Some of the approaches described herein may provide subarray architecture-dependent EIRP mask considerations for MU-MIMO.

Some examples of the techniques described herein may relate to MU-MIMO transmissions as a communications scheme for EIRP masks. For MU-MIMO transmissions, co-scheduled wireless devices (e.g., UEs 115) may be separated in azimuth or elevation domains. Some examples of the techniques described may provide approaches in which wireless device separation or subarray architecture at a network (e.g., gNB) may be incorporated in terms of EIRP masks. For instance, a network entity 105 may receive signals from UEs 115 in different directions. An angular range may be utilized to select a beamforming scheme (e.g., DFT beamforming, such as DFT codebook-based beamforming, zero-forcing beamforming, such as regularized zero-forcing beamforming, or inverse beamforming, such as generalized inverse beamforming, among other examples). For instance, a beamforming scheme may be selected to satisfy an EIRP mask. In some examples, transmit power may be controlled utilizing a backoff scheme that may be selected based on the angular range or associated with a beamforming scheme.

Some examples of wireless devices may include a subarray-based active antenna array system (AAS). In an example, an array of antennas may include Nₜ antennas in the elevation domain (e.g., a linear array Nₜ×1). The array of antennas may be partitioned into N_{TXRU} groups or subarrays, with Nₜ/N_{TXRU} antennas per group or subarray. Each antenna group or subarray may form an antenna panel. Inter-antenna element spacing may be expressed as aλ, where a≥0.5, and λ may denote a wavelength. A steering angle of antenna elements within each group, subarray, or panel may be denoted θₜᵢₗₜ. A steering angle across subarrays may be denoted θ_{subtilt} (where θₜᵢₗₜ≠θ_{subtilt}). A similar setup may be extendable to planar arrays (e.g., for azimuth and elevation domains or dimensions). In some examples, each group, subarray, or panel may be coupled with (e.g., connected to) a respective transceiver unit (TXRU). A TXRU may include one or more circuits (e.g., a transmit or receive chain) for transmitting or receiving signals. In some cases, a TXRU may be coupled with (e.g., interface with) baseband processing circuitry.

In an example, a first subarray or panel may be coupled with TXRU₁, an inter-antenna spacing for antennas or antenna elements in the first subarray (or for antennas or antenna elements in another subarray(s) or panel(s)) may be spaced at aλ, and a beam produced by the first subarray or panel may be steered towards θₜᵢₗₜ; a second subarray or panel may be coupled with TXRU₂ and a beam produced by the second subarray or panel may be steered towards θₜᵢₗₜ; and an Nth subarray or panel may be coupled with TXRU_{N} and a beam produced by the Nth subarray or panel may be steered towards θₜᵢₗₜ. A beam produced across the subarrays or panels may be steered towards θ_{subtilt}. In some aspects, a network entity 105 (e.g., gNB) may schedule multiple UEs 115 with the subarray architecture. For instance, a first beam may be steered to one or more first UEs 115 via θₜᵢₗₜ, and a second beam may be steered to one or more second UEs 115 via θ_{subtilt}.

One or more operation aspects in terms of beamwidth or UE 115 separability may be exhibited or observed. Examples of two scenarios are provided, where a network entity 105 (e.g., gNB) may have a same set of antenna elements, where the antenna elements are coupled with three TXRUs (in the elevation domain, for instance) in a first example and coupled with two TXRUs (in the elevation domain, for instance) in a second example. With N as a quantity of antenna elements coupled with one TXRU, the half power and null-to-null beamwidths of beams steered with the TXRU may be given as ≈101°/N and ≈229°/N, respectively. The null-to-null beamwidths may be computed based on beam patterns for a DFT beam steered towards a boresight direction and computing an angular spread at which half the power and a null in power levels may be observed.

Accordingly, as the quantity of TXRUs decreases (or N per TXRU increases), even as the total quantity of antenna elements remains the same, both beamwidths decrease, which may lead to improved separability of UEs 115 (given a fixed direction of steering across the UEs, for instance) in that dimension. For instance, the subarray architecture (or a configuration underlying the subarray architecture, for example) at a network entity 105 (e.g., gNB) may have a significant impact on the spatial user separability for MU-MIMO. Some examples of the techniques described herein may improve MU-MIMO scheduling or may provide an improved description of an EIRP mask based on the subarray architecture or a quantity of antenna elements per TXRU.

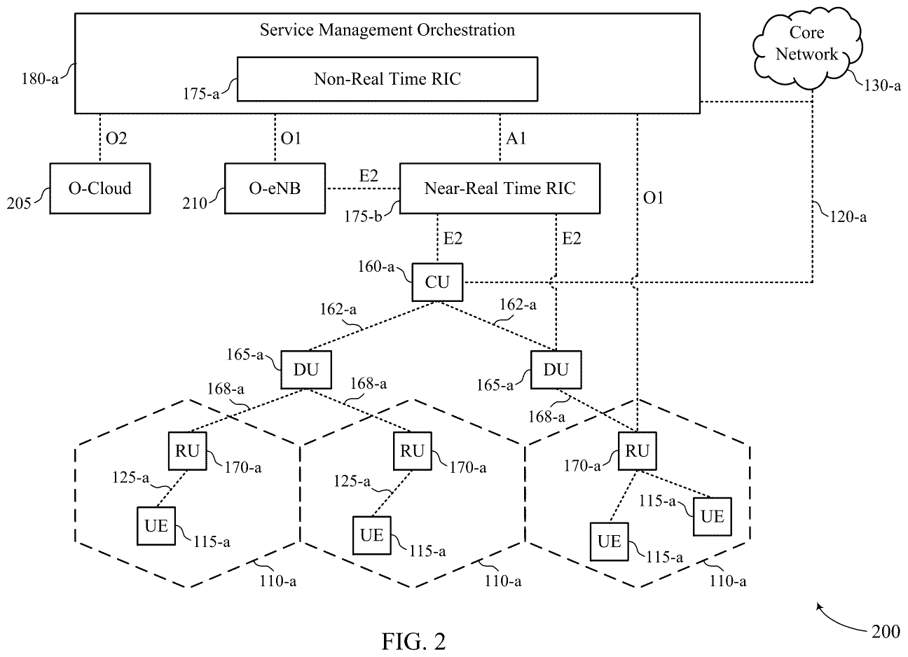

FIG. 2 shows an example of a network architecture 200 (e.g., a disaggregated base station architecture, a disaggregated RAN architecture) that supports directional communications for antenna subarrays in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

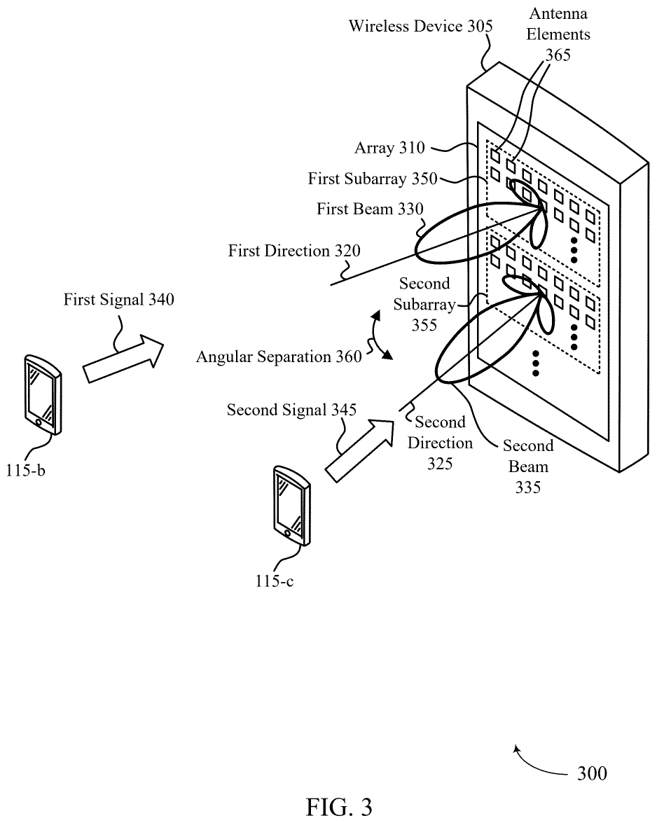

FIG. 3 shows an example of a wireless communications system 300 that supports directional communications for antenna subarrays in accordance with one or more aspects of the present disclosure. For instance, the wireless communications system 300 may include a first UE 115-b, a second UE 115-c, and a wireless device 305. In some aspects, the first UE 115-b or the second UE 115-c may be an example of a UE 115 as described with reference to FIG. 1 or a UE 115-a as described with reference to FIG. 2. In some aspects, the wireless device 305 may be an example of a network entity 105, CU 160, DU 165, or RU 170 as described with reference to FIG. 1, may be an example of a CU 160-a, a DU 165-a, or an RU 170-a as described with reference to FIG. 2, or may be a gNB or a transmission-reception point (TRP).

The wireless device 305 may include an array 310 of antenna elements 365. In some examples (and as illustrated in the example of FIG. 1), the array 310 may include antenna elements 365 in two dimensions (e.g., elevation and azimuth). In some examples, the array 310 may include antenna elements 365 in more dimensions (e.g., three dimensions) or in fewer dimensions (e.g., one dimension).

The wireless device 305 may include a first subarray 350 and a second subarray 355 of antenna elements 365. In some examples, the first subarray 350 and the second subarray 355 may include equal quantities of antenna elements 365 or different quantities of antenna elements 365. In some aspects, the first subarray 350 may include more or fewer antenna elements 365 relative to the second subarray 355. In some approaches, the first subarray 350 and the second subarray 355 may overlap or may be separate. While two subarrays (e.g., the first subarray 350 and the second subarray 355) are illustrated in FIG. 3, a different quantity (e.g., three, four, five, ten, or another quantity) of subarrays may be implemented or utilized. Each subarray may be coupled with one or more TXRUs. For instance, the first subarray 350 may be coupled with a first TXRU or the second subarray 355 may be coupled with a second TXRU.

The wireless device 305 may modify the first subarray 350 or the second subarray 355. For example, the wireless device 305 may change the first subarray 350 or the second subarray 355, may adjust quantities of antenna elements included in the first subarray 350 or the second subarray 355, or may change couplings of one or more TXRUs with the first subarray 350 or the second subarray 355. For instance, the wireless device 305 (e.g., gNB) may include (e.g., may control or select) different subarray architectures (e.g., different quantities of TXRUs, different spacings between antenna elements 365 or TXRUs, or different quantities of antenna elements 365 per TXRU) over time. In some examples, the different subarray architectures may include a same quantity of total antenna elements 365 or different quantities of total antenna elements.

In some approaches, the wireless device 305 may include one or more switches, circuitry, hardware, or instructions (e.g., executable code) for selecting (e.g., partitioning or grouping) the antenna elements 365 into subarrays. For example, one or more switches may be utilized (e.g., controlled) to switch different subarrays to couple with a TXRU or different TXRUs. For instance, a TXRU may be coupled to subarrays with different quantities of antenna elements 365 at different times. Enabling selection of the antenna elements 365 into subarrays may improve flexibility.

The wireless device 305 (e.g., network entity, gNB, or other device) may perform MU-MIMO techniques to communicate with multiple UEs concurrently (e.g., in overlapping time windows or at the same time). For example, the wireless device 305 may communicate with the first UE 115-b and the second UE 115-c concurrently. While two UEs (e.g., the first UE 115-b and the second UE 115-c) are illustrated in the example of FIG. 3, the wireless device 305 may communicate with different quantities of UEs in other examples.

The wireless device 305 may receive a first signal 340 from the first UE 115-b. The first signal 340 may be an RF signal, a light signal, an information signal, an audio signal, another signal, or a combination thereof. The first signal 340 may be received from a first direction 320 at the wireless device 305. For example, the wireless device 305 may receive the first signal 340, which may enable the wireless device 305 to determine the first direction 320 from which the first signal 340 was sent. In some approaches, the wireless device 305 may determine the first direction 320 by comparing the amplitude or phase of the first signal 340 (e.g., an RF signal) received via different antenna elements 365, which may provide an indication of the first direction 320. For instance, an antenna element that receives the first signal 340 with a higher amplitude than another antenna element(s) may be located nearer to the first UE 115-b. Additionally, or alternatively, an antenna element that receives the first signal 340 earlier than another antenna element(s) may be located nearer to the first UE 115-b. The first direction 320 may be determined by determining an angle relative to the array 310 corresponding to measured phase differences of the first signal 340 between two or more of the antenna elements 365.

In some examples, one or more other approaches may be utilized to determine the first direction 320. For instance, the first direction 320 may be based on coordinates (e.g., global positioning system (GPS) coordinates received via an information signal) of the first UE 115-b and coordinates the wireless device 305, may be based on an image(s) of the first UE 115-b or the first signal 340 (e.g., a two-dimensional (2D) image, an infrared image of an infrared signal, an image of a light signal, or a depth image) captured by an image sensor(s) at the wireless device 305, or based on audio from the first UE 115-b or the first signal 340 (e.g., a tone or other sound) captured by an audio sensor(s) (e.g., microphones) at the wireless device 305, among other examples.

The wireless device 305 may receive a second signal 345 from the second UE 115-c. The second signal 345 may be an RF signal, a light signal, an information signal, an audio signal, another signal, or a combination thereof. The second signal 345 may be received from a second direction 325 at the wireless device 305. For example, the wireless device 305 may receive the second signal 345, which may enable the wireless device 305 to determine the second direction 325 from which the second signal 345 was sent. In some approaches, the wireless device 305 may determine the second direction 325 by comparing the amplitude or phase of the second signal 345 (e.g., an RF signal) received via different antenna elements 365, which may provide an indication of the second direction 325. For instance, an antenna element that receives the second signal 345 with a higher amplitude than another antenna element(s) may be located nearer to the second UE 115-c. Additionally, or alternatively, an antenna element that receives the second signal 345 earlier than another antenna element(s) may be located nearer to the second UE 115-c. The second direction 325 may be determined by determining an angle relative to the array 310 corresponding to measured phase differences of the second signal 345 between two or more of the antenna elements 365.

In some examples, one or more other approaches may be utilized to determine the second direction 325. For instance, the second direction 325 may be based on coordinates (e.g., GPS coordinates received via an information signal) of the second UE 115-c and coordinates the wireless device 305, may be based on an image(s) of the second UE 115-c or the second signal 345 (e.g., a two-dimensional (2D) image, an infrared image of an infrared signal, an image of a light signal, or a depth image) captured by an image sensor(s) at the wireless device 305, or based on audio from the second UE 115-c or the second signal 345 (e.g., a tone or other sound) captured by an audio sensor(s) (e.g., microphones) at the wireless device 305, among other examples.

The wireless device 305 may communicate with the first UE 115-b, via a first beam 330 from the first subarray 350 of antennas, concurrently with the second UE 115-c via a second beam 335 from the second subarray 355 of antennas. The first beam 330 or the second beam 335 may be generated with a first beamforming scheme or a second beamforming scheme. A beamforming scheme may be a technique for forming a beam or may include one or more operations for beamforming. For example, the first beamforming scheme may be (or may include) DFT beamforming (e.g., DFT codebook-based beamforming) or beamforming with beam weights with a progressive phase shift, among other examples. Additionally, or alternatively, the second beamforming scheme may be (or may include) zero-forcing beamforming (e.g., regularized zero-forcing beamforming) or inverse beamforming (e.g., generalized inverse beamforming), among other examples. The first beamforming scheme or the second beamforming scheme may be applied to the first subarray 350 of antennas or the second subarray 355 of antennas.

In some examples, the wireless device 305 may select the first beamforming scheme or the second beamforming scheme based on an angular separation 360 between the first direction 320 and the second direction 325. For instance, the wireless device 305 may select the first beamforming scheme or the second beamforming scheme based on a threshold (e.g., an angular threshold). Examples of the threshold may include 2°, 3°, 5°, 10°, 15°, 25°, 30°, 45°, 60°, or another value. In some approaches, the first beamforming scheme may be selected if the angular separation 360 satisfies the threshold or the second beamforming scheme may be selected if the angular separation 360 does not satisfy the threshold. As used herein, “satisfying a threshold” may, depending on the context, refer to a value being greater than the threshold, greater than or equal to the threshold, less than the threshold, less than or equal to the threshold, equal to the threshold, not equal to the threshold, or the like. Depending on an AAS subarray architecture or configuration used at the wireless device 305 (e.g., gNB), for example, UEs with angle of departure (AOD) or zenith angle of departure (ZOD) (of dominant clusters, for instance) that are beyond an angular threshold may be co-scheduled with DFT beams (which may be based on a progressive phase shift across the antenna array 310 or subarray).

If the AOD or ZOD of the first UE 115-b and the second UE 115-c is within the angular threshold, then a zero-forcing (e.g., regularized zero-forcing) or generalized inverse beam may be utilized, which may ensure that the second UE 115-c receives or detects less interference due to transmissions for the first UE 115-b (or that the first UE 115-b receives or detects less interference due to transmissions for the second UE 115-c). For instance, if the angular separation (e.g., AOD or ZOD) is within the threshold, DFT beams may exhibit degraded performance for MU-MIMO communications. For instance, a zero-forcing (e.g., regularized zero-forcing) or inverse (e.g., generalized inverse) beam may reduce interference along the second direction 325 of the second UE 115-c (which, may be below the horizon). In some cases, a zero-forcing or regularized inverse beam may lead to increased interference in one or more other directions (e.g., above the horizon where one or more victim nodes may be located).

In some aspects, the threshold may be a function of a first size of the first subarray 350, a second size of the second subarray 355, or a combination thereof. For instance, the angular threshold may decrease as array dimensions increase. In some approaches, the first UE 115-b and the second UE 115-c may be co-scheduled (e.g., scheduled concurrently or in overlapping time frames) if the angular separation 360 (e.g., AOD or ZOD) is beyond the angular threshold (which may be associated with subarray dimensions).

In some examples, the wireless device 305 may receive, from a network entity, configuration information indicating the threshold. For instance, a network entity (e.g., an access and mobility management function (AMF), location management function (LMF), a server, or another device, among other examples) may output (e.g., transmit), or the wireless device 305 (e.g., a gNB, RU, or TRP, among other examples) may obtain (e.g., receive), the configuration information indicating the threshold.

In some approaches, a first transmit power associated with the first beam 330 may be controlled, or a second power associated with the second beam 335 may be controlled, in accordance with a first power backoff scheme associated with the first beamforming scheme or in accordance with a second power backoff scheme associated with the second beamforming scheme. A power backoff scheme may be a technique, or may include one or more operations, for controlling an amount of transmission power (for one or more beams, for instance). In some examples, a power backoff scheme may include one or more limits for transmission power associated with one or more directions (e.g., a range of directions). For instance, a power backoff scheme may limit the power of transmissions (to within a limit in dB, for instance) for transmissions in a range of directions (e.g., above an angle or above a horizontal plane, for instance). In some aspects, a power backoff scheme may limit the power of transmissions (e.g., to a limit of −3 dB, −5 dB, or −10 dB, among other examples) above an angle (e.g., above horizontal, above 3°, above 5°, or above 10°, among other examples). In some examples, a power backoff scheme may be an EIRP mask or may be associated with an EIRP mask. While examples of power backoff schemes are provided in terms of elevation angles, a power backoff may additionally, or alternatively, include power limits that vary with one or more other dimensions (e.g., azimuth).

In some examples, the second power backoff scheme may be associated with the second beamforming scheme that may be selected when the angular separation 360 is within the threshold. For instance, when the wireless device 305 (e.g., gNB) is to co-schedule UEs with AODs or ZODs of dominant clusters that are within the threshold (e.g., within an AAS subarray architecture or configuration-dependent angular threshold), the wireless device 305 may utilize the second power backoff scheme. In some examples, the second power backoff scheme may be (or may include) a second EIRP backoff. The second EIRP backoff (which may be denoted X₁ in dB or may be denoted differently in other examples) may correspond to a default EIRP mask (e.g., may be associated with an EIRP mask for single-user (SU) MIMO transmissions). In some approaches, the second power backoff scheme may be (or may include) a backoff that may be specified in one or more specifications or regulations. In some examples, the wireless device 305 (e.g., gNB) may select or utilize (e.g., incorporate) the second power backoff scheme based on one or more distances to the first UE 115-b or to the second UE 115-c (e.g., how far away the co-scheduled UEs are located from the wireless device 305). In some examples, conformance or testing aspects to ensure compliance with the EIRP backoff may be specified. In some aspects, the first power backoff scheme and the second power backoff scheme may differ from each other. For instance, the first power backoff scheme may include different limits or different angular ranges for transmissions.

In some examples, the first power backoff scheme may be associated with the first beamforming scheme that may be selected when the angular separation 360 is satisfies (e.g., is greater than or equal to) the threshold. For example, the wireless device 305 may utilize a first EIRP backoff (which may be denoted X₂ in dB or may be denoted differently in other examples). For example, the first EIRP backoff may be utilized based on an AAS subarray architecture or configuration used. In some examples, the first EIRP backoff may be associated with an EIRP backoff for SU MIMO transmissions.

In some approaches, the first power backoff scheme may increase a degree of power backoff in association with an increased quantity of antennas of the first subarray 350 or of the second subarray 355. For instance, the first EIRP backoff may increase as antenna elements in the elevation domain of each subarray increases. The first EIRP backoff may be specified in some examples.

In some aspects, the wireless device 305 may control (e.g., select, group, partition, or switch among other examples) subarrays of the antenna elements 365 to perform the first power backoff scheme or to perform the second power backoff scheme. For instance, the wireless device 305 may control the first subarray 350, the second subarray 355, or a combination thereof to satisfy one or more EIRP mask criteria (e.g., to stay within a radiated power limit in a directional range or ranges). In some approaches, different wireless devices (e.g., gNBs) may include or utilize different architectures (e.g., different quantities of total antenna elements, different quantities of TXRUs, or different quantities of antenna elements per TXRU, among other examples).

In some approaches, at least one of the first subarray 350 or the second subarray 355 in the first beamforming scheme is respectively larger than at least one of the first subarray 350 or the second subarray 355 in the second beamforming scheme. For instance, the first subarray 350 may include more antenna elements 365 in the first beamforming scheme than in the second beamforming scheme.

In some examples, the wireless device 305 may transmit a synchronization signal block (SSB) via the first beam 330 or the second beam 335. The first UE 115-b or the second UE 115-c may receive the SSB (e.g., and measure the SSB) to determine a characteristic of the SSB (e.g., signal power, phase, a beam with a greatest power or quality, or another characteristic). The first UE 115-b or the second UE 115-c may transmit, or the wireless device 305 may obtain (e.g., receive) a signal indicating the characteristic of the SSB. A degree of power backoff of the first power backoff scheme or of the second power backoff scheme may be based on (e.g., determined in association with) the characteristic of the SSB. For instance, the first EIRP backoff or the second EIRP backoff may be based on beam feedback (e.g., information indicating a beam with a highest power or quality in a set of beams, for instance) associated with the SSB(s). For instance, the wireless device 305 may transmit a set of beams, which may be beams with angular deviation between directions of serving transmission configuration indicator (TCI) states of co-scheduled UEs.

Some approaches may not determine whether grouping UEs may allow a gNB to meet an EIRP mask. In accordance with some of the techniques described herein, UEs may be grouped in MU-MIMO scheduling if (e.g., only if, or based on a condition that) the transmissions to the UEs are such that the wireless device 305 (e.g., gNB) may meet the EIRP mask.

In some approaches, the first UE 115-b may be grouped in a first group of one or more UEs or the second UE 115-c may be grouped in a second group of one or more UEs to satisfy an EIRP limit over an angular range from the wireless device 305. For instance, the wireless device 305 may select a grouping of UEs to satisfy an EIRP limit or mask in accordance with the first power backoff scheme or the second power backoff scheme. In some aspects, the first group of one or more UEs or the second group of one or more UEs may be included in a MU-MIMO communication from the wireless device 305. For MU-MIMO, for instance, UE grouping decisions may be performed by the wireless device 305 (e.g., by a gNB scheduler of a gNB).

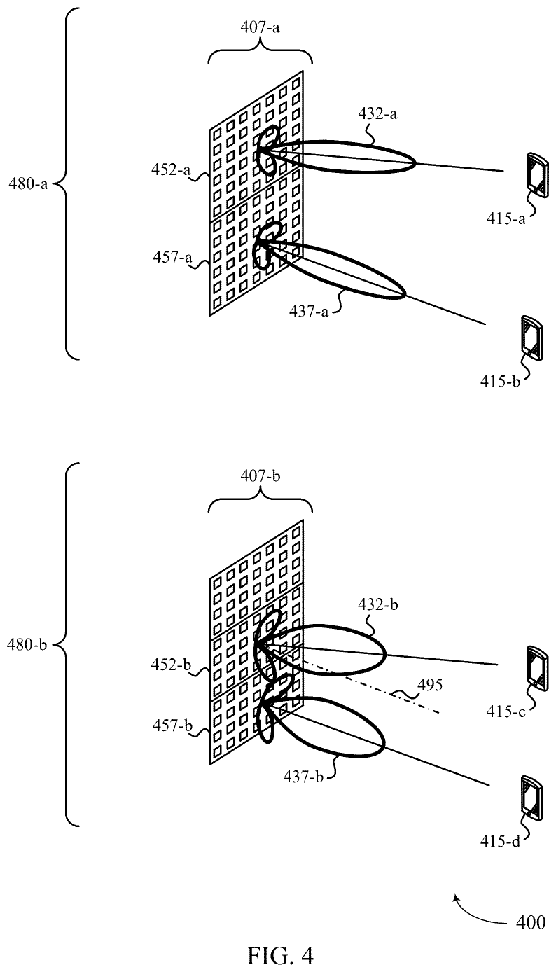

FIG. 4 shows a diagram 400 illustrating examples of beamforming that support directional communications for antenna subarrays in accordance with one or more aspects of the present disclosure. FIG. 4 illustrates a first scenario 480-a and a second scenario 480-b. The wireless communications system 100, the network architecture 200, or the wireless communications system 300 may operate in accordance with one or more aspects of the first scenario 480-a or the second scenario 480-b in some approaches. For example, a UE 115 or a network entity 105 described with reference to FIG. 1, the UE 115-a, CU 160-a, the DU 165-a, or the RU 170-a described with reference to FIG. 2, or the first UE 115-b, the second UE 115-c, or the wireless device 305 described with reference to FIG. 3 may operate in accordance with one or more aspects of the first scenario 480-a or the second scenario 480-b.

The first scenario 480-a includes an array 407-a, a UE 415-a, and a UE 415-b. The array 407-a may be an example of the array 310 described with reference to FIG. 3. The array 407-a may include a first subarray 452-a and a second subarray 457-a. The first subarray 452-a may produce a first beam 432-a steered towards the UE 415-a. The second subarray 457-a may produce a second beam 437-a steered towards the UE 415-b.

The second scenario 480-b includes an array 407-b, a UE 415-c, and a UE 415-d. The array 407-b may be an example of the array 310 described with reference to FIG. 3. The array 407-b may include a first subarray 452-b and a second subarray 457-b. The first subarray 452-b may produce a first beam 432-b steered towards the UE 415-c. The second subarray 457-b may produce a second beam 437-b steered towards the UE 415-d.

In the first scenario 480-a and in the second scenario 480-b, the steering directions of the first beam 432-a for the UE 415-a and of the first beam 432-b for the UE 415-c are the same. Additionally, in the first scenario 480-a and in the second scenario 480-b, the steering directions of the second beam 437-a for the UE 415-b and of the second beam 437-b for the UE 415-d are the same. In the first scenario 480-a, the first beam 432-a (e.g., a DFT beam) for the UE 415-a and the second beam 437-a (e.g., a DFT beam) along these directions avoid causing significant interference with each other (e.g., the first beam 432-a avoids causing significant interference for the UE 415-b, and the second beam 437-a avoids causing significant interference for the UE 415-a). In the second scenario 480-b, the first beam 432-b (e.g., a DFT beam) for the UE 415-c causes interference 495 for the UE 415-d (e.g., inter-UE interference, where a DFT beam for the UE 415-c causes interference for the UE 415-d).

As illustrated in FIG. 4, the first subarray 452-a in the first scenario 480-a includes more antenna elements in the elevation domain than the first subarray 452-b in the second scenario 480-b. Accordingly, the peak gain in the elevation dimension is increased in the first scenario 480-a relative to the peak gain in the second scenario 480-b (proportionate to the first subarray 452-a size). Additionally, the beamwidth of the first beam 432-a in the first scenario 480-a is narrower than the beamwidth of the first beam 432-b in the second scenario 480-b. While the narrower beamwidth of the first beam 432-a for the UE 415-a in the first scenario 480-a may help to avoid interference for the UE 415-b, on an absolute scale, interference caused in a one or more directions (e.g., in the direction of the main lobe or sidelobes) may also be higher.

In accordance with some of the techniques described herein, beamforming schemes or power backoff schemes may be selected based on a separation angle between UEs or UE groups. For instance, a DFT beamforming scheme (e.g., DFT codebook-based beamforming) with larger subarrays may be selected when a separation angle between the UE 415-a and the UE 415-b is less than a threshold as provided in the first scenario 480-a, which may help to avoid the interference 495 that may be caused with smaller subarrays in the second scenario 480-b.

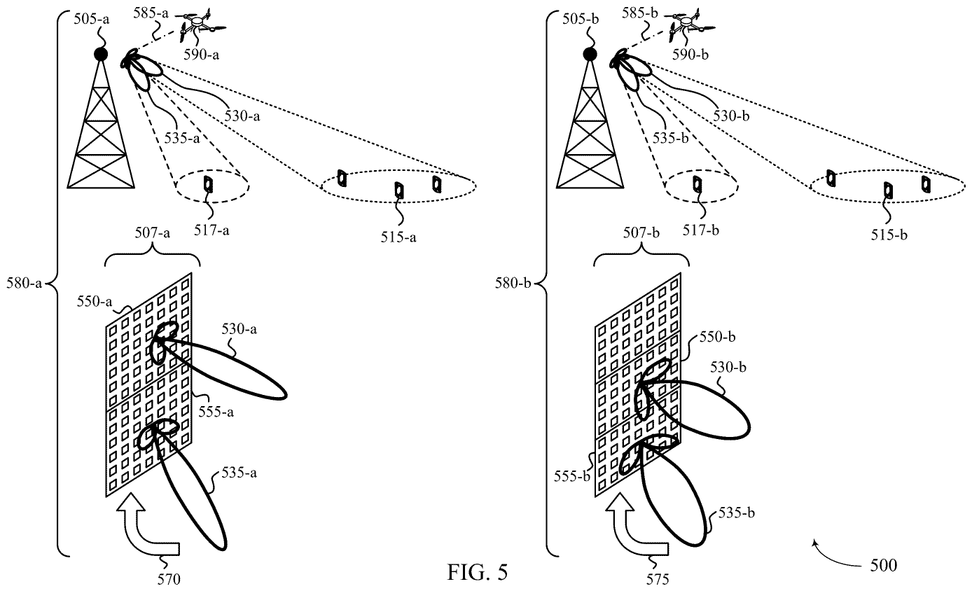

FIG. 5 shows diagram 500 illustrating examples of beamforming that support directional communications for antenna subarrays in accordance with one or more aspects of the present disclosure. FIG. 5 illustrates a first scenario 580-a and a second scenario 580-b. The wireless communications system 100, the network architecture 200, or the wireless communications system 300 may operate in accordance with one or more aspects of the first scenario 580-a or the second scenario 580-b in some approaches. For example, a UE 115 or a network entity 105 described with reference to FIG. 1, the UE 115-a, CU 160-a, the DU 165-a, or the RU 170-a described with reference to FIG. 2, or the first UE 115-b, the second UE 115-c, or the wireless device 305 described with reference to FIG. 3 may operate in accordance with one or more aspects of the first scenario 580-a or the second scenario 580-b.

The first scenario 580-a includes a wireless device 505-a that includes an array 507-a, a UE 515-a, and UEs 515-b. The wireless device 505-a may be an example of the wireless device 305 (e.g., a gNB) described with reference to FIG. 3. The array 507-a may be an example of the array 310 described with reference to FIG. 3. The array 507-a may include a first subarray 550-a and a second subarray 555-a. The first subarray 550-a may produce a first beam 530-a steered towards UEs 515-a. The second subarray 555-a may produce a second beam 535-a steered towards a UE 515-b.

The second scenario 580-b includes a wireless device 505-b that includes an array 507-b, UEs 515-b, and a UE 517-b. The wireless device 505-b may be an example of the wireless device 305 (e.g., a gNB) described with reference to FIG. 3. The array 507-b may be an example of the array 310 described with reference to FIG. 3. The array 507-b may include a first subarray 550-b and a second subarray 555-b. The first subarray 550-b may produce a first beam 530-b steered towards the UEs 515-b. The second subarray 555-b may produce a second beam 535-b steered towards the UE 517-b.

As illustrated in FIG. 5, the first subarray 550-a in the first scenario 580-a may include more antenna elements than the first subarray 550-b in the second scenario 580-b. The second subarray 555-a in the first scenario 580-a may include more antenna elements than the second subarray 555-b in the second scenario 580-b. Due to the increased quantity of antenna elements in the first scenario 580-a, the beamwidths of the first beam 530-a and of the second beam 535-a may allow a first beamforming scheme (e.g., or a first power backoff scheme) to be utilized in the first scenario 580-a. For instance, the increased array size in the elevation domain may allow DFT beamforming (e.g., DFT codebook-based beamforming) or beamforming with beam weights with a progressive phase shift applied to the first subarray 550-a of antennas or the second subarray 555-a of antennas. For instance, the increased array size may allow a threshold to be decreased, such that smaller angular separations between the UEs 515-a and the UE 517-a may satisfy the threshold and allow DFT beamforming or beamforming with beam weights with a progressive phase shift applied to the first subarray 550-a of antennas or the second subarray 555-a of antennas. In some cases, the increased subarray size in the elevation domain may lead to increased interference 585-a for a victim node 590-a (e.g., a drone). In some examples, the wireless device 505-a may apply a first power backoff scheme 570 (e.g., X₂ in dB). Utilizing the first beamforming scheme or the first power backoff scheme 570 may allow the wireless device 505-a to transmit via the first beam 530-a and the second beam 535-a while satisfying an EIRP mask or limit.

As illustrated in FIG. 5, the first subarray 550-b in the second scenario 580-b may include fewer antenna elements than the first subarray 550-a in the first scenario 580-a. The second subarray 555-b in the second scenario 580-b may include fewer antenna elements than the second subarray 555-a in the first scenario 580-a. Due to the decreased quantity of antenna elements in the second scenario 580-b, the beamwidths of the first beam 530-b and of the second beam 535-b may allow a second beamforming scheme (e.g., or a second power backoff scheme) to be utilized in the second scenario 580-b. For instance, the decreased array size in the elevation domain may allow zero-forcing beamforming (e.g., regularized zero-forcing beamforming) or inverse beamforming (e.g., generalized inverse beamforming) applied to the first subarray 550-b of antennas or the second subarray 555-b of antennas. For instance, the decreased array size may allow a threshold to be increased, such that smaller angular separations between the UEs 515-b and the UE 517-b may not satisfy the threshold, which may lead to selection of zero-forcing beamforming (e.g., regularized zero-forcing beamforming) or inverse beamforming (e.g., generalized inverse beamforming) applied to the first subarray 550-b of antennas or the second subarray 555-b of antennas. In some cases, the decreased subarray size in the elevation domain may lead to increased interference 585-b for a victim node 590-b (e.g., a drone) due to an inability to separate UEs with DFT beams. In some examples, the wireless device 505-b may apply a second power backoff scheme 575 (e.g., X₁ in dB). Utilizing the second beamforming scheme or the second power backoff scheme 575 may allow the wireless device 505-b to transmit via the first beam 530-b and the second beam 535-b while satisfying an EIRP mask or limit.

Some examples of the technique described herein may provide an EIRP mask framework to be utilized for MU-MIMO transmissions. Some approaches may account for (e.g., may account only for) single-user transmissions in EIRP mask definitions. Increased interference levels may be a concern in some cases. Some examples of the techniques described herein may impact MU-MIMO transmissions to provide transmissions to multiple UEs or groups of UEs while reducing or avoiding interference to one or more other devices (e.g., victim nodes).

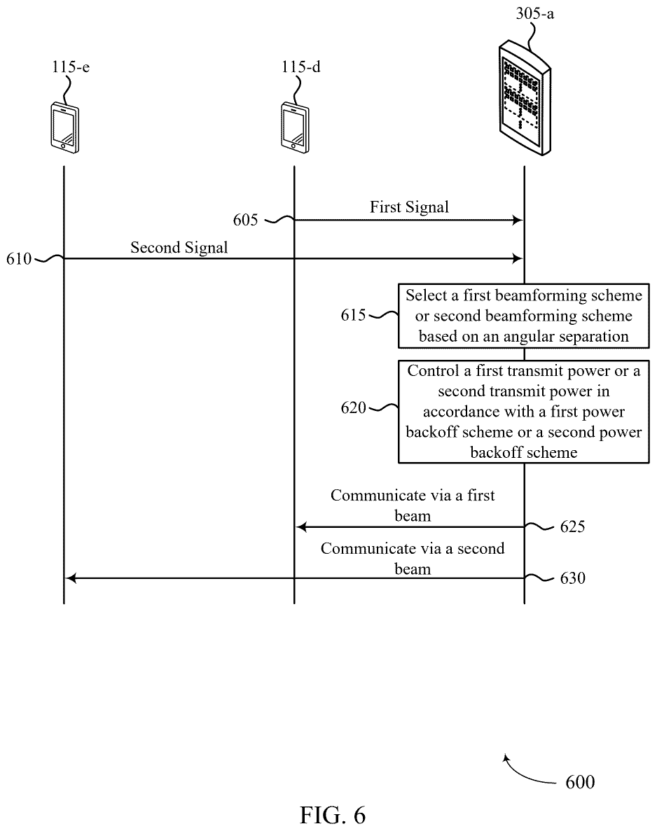

FIG. 6 shows an example of a process flow 600 that supports directional communications for antenna subarrays in accordance with one or more aspects of the present disclosure. A wireless communication system may include a first UE 115-d, a second UE 115-e, and a wireless device 305-a. The first UE 115-d or the second UE 115-e may be an example of the UEs 115, UEs 115-a, the first UE 115-b, the second UE 115-c, the UE 415-a, the UE 415-b, the UE 415-c, the UE 415-d, the UEs 515-a, the UE 517-a, the UEs 515-b, or the UE 517-a, as described herein. Additionally, or alternatively, the wireless device 305-a may be an example of the network entities 105, the CU 160, DU 165, the RU 170, the CU 160-a, DU 165-a, the RU 170-a, the wireless device 305, the wireless device 505-a, or the wireless device 505-b, as described herein.

In the following description of the process flow 600, the communications between the wireless device 305-a, the first UE 115-d, or the second UE 115-e may be transmitted in a different order than the example order shown, or the operations performed by the wireless device 305-a, the first UE 115-d, or the second UE 115-e may be performed in different orders or at different times. One or more operations may be omitted from the process flow 600, or one or more operations may be added to the process flow 600. Further, although some operations or signaling may be shown to occur at different times for discussion purposes, these operations may actually occur at the same time or in overlapping time periods in some examples.

At 605, the first UE 115-d may transmit a first signal to the wireless device 305-a. Transmitting the first signal may be performed as described with reference to FIG. 3. For example, the first UE 115-d may transmit an RF signal (e.g., reference signal), a signal indicating position information (e.g., GPS coordinates), an infrared signal, a light signal, an audio signal, or a combination thereof. The first signal may indicate, or may be utilized to determine, a first direction from which the first signal is transmitted (e.g., a direction of the first UE 115-d relative to the wireless device 305-a).

At 610, the second UE 115-e may transmit a second signal to the wireless device 305-a. Transmitting the second signal may be performed as described with reference to FIG. 3. For example, the second UE 115-e may transmit an RF signal (e.g., reference signal), a signal indicating position information (e.g., GPS coordinates), an infrared signal, a light signal, an audio signal, or a combination thereof. The second signal may indicate, or may be utilized to determine, a second direction from which the second signal is transmitted (e.g., a direction of the second UE 115-e relative to the wireless device 305-a).

At 615, the wireless device 305-a may select a first beamforming scheme or a second beamforming scheme based on an angular separation between the first direction of the first UE 115-d and a second direction of the second UE 115-e. In some examples, selecting the first beamforming scheme or the second beamforming scheme may be performed as described with reference to FIG. 3. For example, the wireless device 305-a may compare the angular separation (e.g., a difference between the first direction and the second direction) to a threshold. The wireless device 305-a may select the first beamforming scheme (e.g., DFT codebook-based beamforming or beamforming with beam weights with a progressive phase shift) if the angular separation satisfies the threshold, or may select the second beamforming scheme (e.g., regularized zero-forcing beamforming or generalized inverse beamforming) if the angular separation does not satisfy the threshold. In some examples, the threshold may be based on (e.g., may be determined based on) a first quantity of antennas corresponding to a first subarray of antennas or a second quantity of antennas corresponding to second subarray of antennas. For instance, the threshold may be reduced for a relatively larger quantity of antennas in the first subarray or in the second subarray, or may be increased for a relatively lesser quantity of antennas in the first subarray or in the second subarray.

At 620, the wireless device 305-a may control a first transmit power or a second transmit power in accordance with a first power backoff scheme or a second power backoff scheme. In some examples, controlling the first transmit power or the second transmit power may be performed as described with reference to FIG. 3. For example, the wireless device 305-a may compare the angular separation (e.g., a difference between the first direction and the second direction) to a threshold. The wireless device 305-a may select the first power backoff scheme (e.g., a first EIRP mask or limit) if the angular separation satisfies the threshold, or may select the second power backoff scheme (e.g., a second EIRP mask or limit) if the angular separation does not satisfy the threshold. Additionally, or alternatively, the wireless device 305-a may utilize or select the first power backoff scheme in association with the first beamforming scheme, or may utilize or select the second power backoff scheme in association with the second beamforming scheme.

At 625, the wireless device 305-a may communicate via a first beam. In some examples, communicating via a first beam may be performed as described with reference to FIG. 3. For example, the wireless device 305-a may transmit one or more signals or may receive one or more signals via a first beam that is formed via a first subarray of antennas. The first beam may be formed utilizing the first beamforming scheme or the second beamforming scheme, or may be transmitted with the first transmit power or the second transmit power utilizing the first power backoff scheme or the second power backoff scheme.

At 630, the wireless device 305-a may communicate via a second beam. In some examples, communicating via a second beam may be performed as described with reference to FIG. 3. For example, the wireless device 305-a may transmit one or more signals or may receive one or more signals via a second beam that is formed via a second subarray of antennas. The second beam may be formed utilizing the first beamforming scheme or the second beamforming scheme, or may be transmitted with the first transmit power or the second transmit power utilizing the first power backoff scheme or the second power backoff scheme.

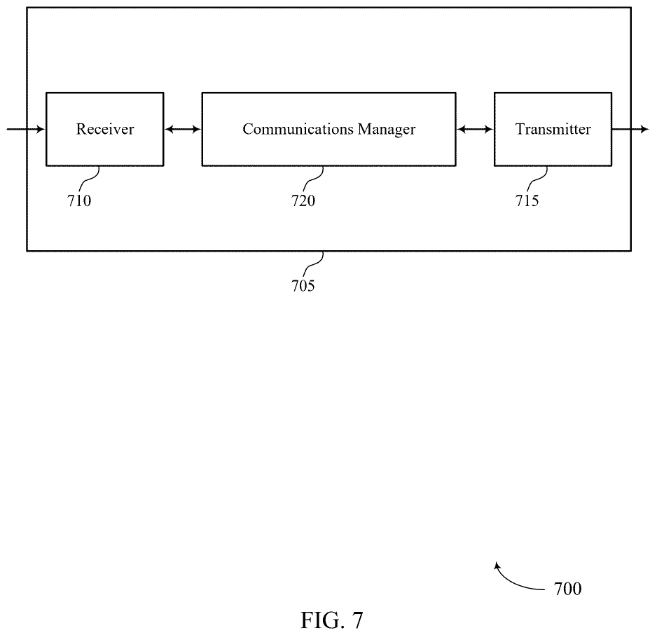

FIG. 7 shows a block diagram 700 of a device 705 that supports directional communications for antenna subarrays in accordance with one or more aspects of the present disclosure. The device 705 may be an example of aspects of a wireless device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of directional communications for antenna subarrays as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for receiving a first signal from a first UE, where the first signal is received from a first direction at the wireless device. The communications manager 720 is capable of, configured to, or operable to support a means for receiving a second signal from a second UE, where the second signal is received from a second direction at the wireless device. The communications manager 720 is capable of, configured to, or operable to support a means for communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

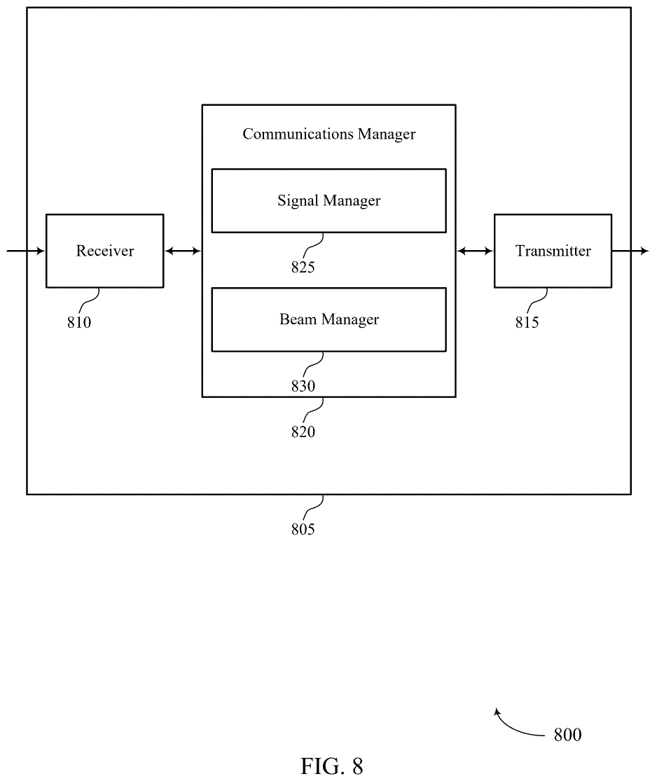

FIG. 8 shows a block diagram 800 of a device 805 that supports directional communications for antenna subarrays in accordance with one or more aspects of the present disclosure. The device 805 may be an example of aspects of a device 705 or a wireless device 305 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of directional communications for antenna subarrays as described herein. For example, the communications manager 820 may include a signal manager 825 a beam manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The signal manager 825 is capable of, configured to, or operable to support a means for receiving a first signal from a first UE, where the first signal is received from a first direction at the wireless device. The signal manager 825 is capable of, configured to, or operable to support a means for receiving a second signal from a second UE, where the second signal is received from a second direction at the wireless device. The beam manager 830 is capable of, configured to, or operable to support a means for communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

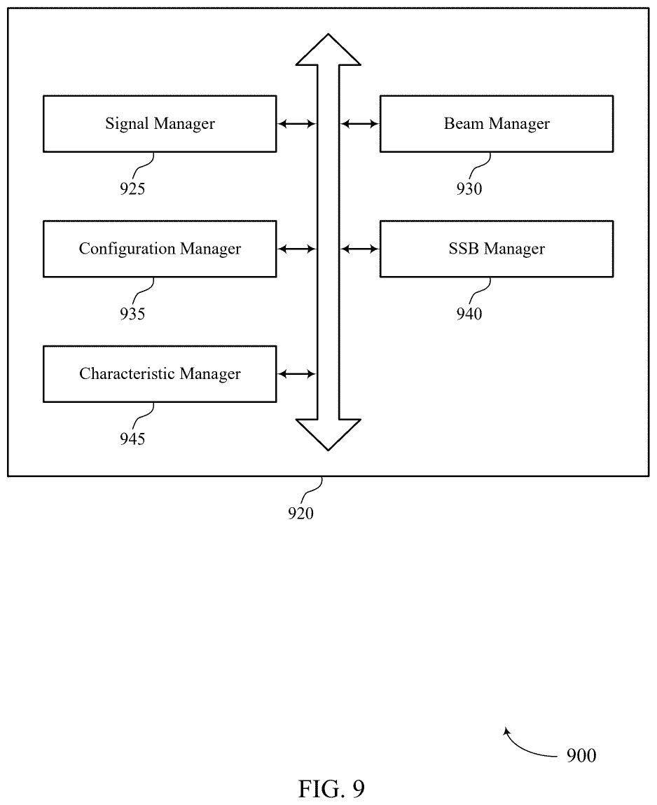

FIG. 9 shows a block diagram 900 of a communications manager 920 that supports directional communications for antenna subarrays in accordance with one or more aspects of the present disclosure. The communications manager 920 may be an example of aspects of a communications manager 720, a communications manager 820, or both, as described herein. The communications manager 920, or various components thereof, may be an example of means for performing various aspects of directional communications for antenna subarrays as described herein. For example, the communications manager 920 may include a signal manager 925, a beam manager 930, a configuration manager 935, an SSB manager 940, a characteristic manager 945, or any combination thereof. Each of these components, or components or subcomponents thereof (e.g., one or more processors, one or more memories), may communicate, directly or indirectly, with one another (e.g., via one or more buses).

The signal manager 925 is capable of, configured to, or operable to support a means for receiving a first signal from a first UE, where the first signal is received from a first direction at the wireless device. In some examples, the signal manager 925 is capable of, configured to, or operable to support a means for receiving a second signal from a second UE, where the second signal is received from a second direction at the wireless device. The beam manager 930 is capable of, configured to, or operable to support a means for communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

In some examples, the first beamforming scheme includes DFT beamforming (e.g., DFT codebook-based beamforming) or beamforming with beam weights with a progressive phase shift applied to the first subarray of antennas or the second subarray of antennas.

In some examples, the second beamforming scheme includes zero-forcing beamforming (e.g., regularized zero-forcing beamforming) or inverse beamforming (e.g., generalized inverse beamforming).

In some examples, the beam manager 930 is capable of, configured to, or operable to support a means for selecting the first beamforming scheme or the second beamforming scheme based on a threshold, where the first beamforming scheme is selected if the angular separation satisfies the threshold or the second beamforming scheme is selected if the angular separation does not satisfy the threshold.

In some examples, the configuration manager 935 is capable of, configured to, or operable to support a means for receiving, from a network entity, configuration information indicating the threshold.

In some examples, the threshold is a function of a first size of the first subarray, a second size of the second subarray, or a combination thereof.

In some examples, at least one of the first subarray or the second subarray in the first beamforming scheme is respectively larger than at least one of the first subarray or the second subarray in the second beamforming scheme.

In some examples, the first power backoff scheme increases a degree of power backoff in association with an increased quantity of antennas of the first subarray or of the second subarray.

In some examples, the SSB manager 940 is capable of, configured to, or operable to support a means for transmitting an SSB via the first beam or the second beam. In some examples, the characteristic manager 945 is capable of, configured to, or operable to support a means for receiving a signal indicating a characteristic of the SSB, where a degree of power backoff of the first power backoff scheme or of the second power backoff scheme is based on the characteristic of the SSB.

In some examples, the first UE is grouped in a first group of one or more UEs and the second UE is grouped in a second group of one or more UEs to satisfy an EIRP limit over an angular range from the wireless device.

In some examples, the first group of one or more UEs and the second group of one or more UEs are included in a multi-user multiple-input multiple-output (MU-MIMO) communication from the wireless device.

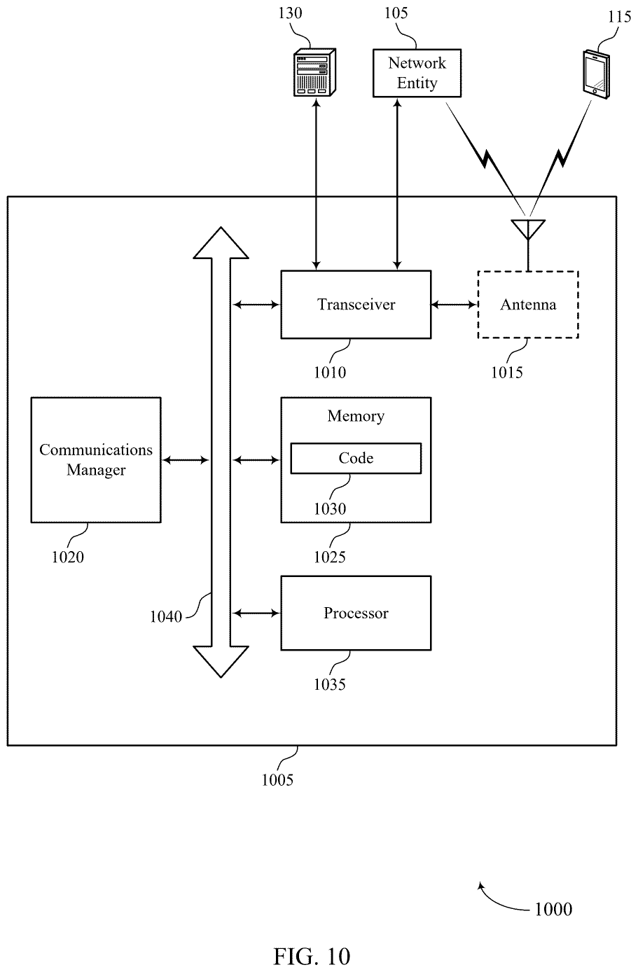

FIG. 10 shows a diagram of a system 1000 including a device 1005 that supports directional communications for antenna subarrays in accordance with one or more aspects of the present disclosure. The device 1005 may be an example of or include components of a device 705, a device 805, or a wireless device as described herein. The device 1005 may include components for bi-directional voice and data communications including components for transmitting and receiving communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting directional communications for antenna subarrays). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

For example, the communications manager 1020 is capable of, configured to, or operable to support a means for receiving a first signal from a first UE, where the first signal is received from a first direction at the wireless device. The communications manager 1020 is capable of, configured to, or operable to support a means for receiving a second signal from a second UE, where the second signal is received from a second direction at the wireless device. The communications manager 1020 is capable of, configured to, or operable to support a means for communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme.

By including or configuring the communications manager 1020 in accordance with examples as described herein, the device 1005 may support techniques for improved communication reliability, reduced latency, reduced power consumption, more efficient utilization of communication resources, improved coordination between devices, longer battery life, or improved utilization of processing capability.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of directional communications for antenna subarrays as described herein, or the at least one processor 1035 and the at least one memory 1025 may be otherwise configured to, individually or collectively, perform or support such operations.

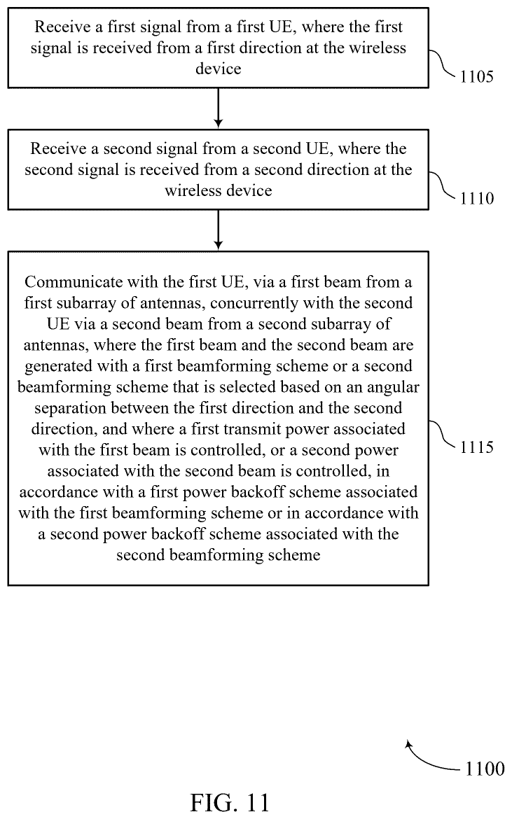

FIG. 11 shows a flowchart illustrating a method 1100 that supports directional communications for antenna subarrays in accordance with one or more aspects of the present disclosure. The operations of the method 1100 may be implemented by a wireless device or its components as described herein. For example, the operations of the method 1100 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1105, the method may include receiving a first signal from a first UE, where the first signal is received from a first direction at the wireless device. The operations of 1105 may be performed in accordance with examples as disclosed herein. In some examples, aspects of the operations of 1105 may be performed by a signal manager 925 as described with reference to FIG. 9.

At 1110, the method may include receiving a second signal from a second UE, where the second signal is received from a second direction at the wireless device. The operations of 1110 may be performed in accordance with examples as disclosed herein. In some examples, aspects of the operations of 1110 may be performed by a signal manager 925 as described with reference to FIG. 9.

At 1115, the method may include communicating with the first UE, via a first beam from a first subarray of antennas, concurrently with the second UE via a second beam from a second subarray of antennas, where the first beam and the second beam are generated with a first beamforming scheme or a second beamforming scheme that is selected based on an angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme. The operations of 1115 may be performed in accordance with examples as disclosed herein. In some examples, aspects of the operations of 1115 may be performed by a beam manager 930 as described with reference to FIG. 9.

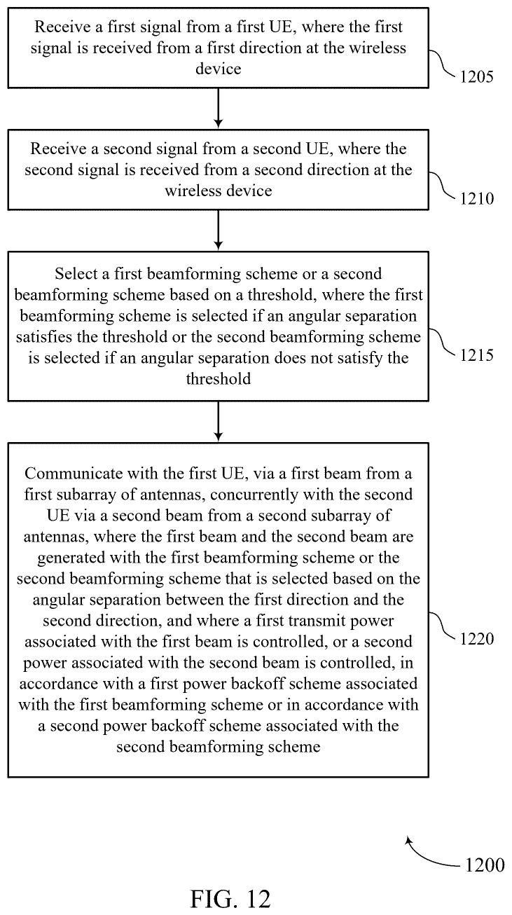

FIG. 12 shows a flowchart illustrating a method 1200 that supports directional communications for antenna subarrays in accordance with one or more aspects of the present disclosure. The operations of the method 1200 may be implemented by a wireless device or its components as described herein. For example, the operations of the method 1200 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1205, the method may include receiving a first signal from a first UE, where the first signal is received from a first direction at the wireless device. The operations of 1205 may be performed in accordance with examples as disclosed herein. In some examples, aspects of the operations of 1205 may be performed by a signal manager 925 as described with reference to FIG. 9.

At 1210, the method may include receiving a second signal from a second UE, where the second signal is received from a second direction at the wireless device. The operations of 1210 may be performed in accordance with examples as disclosed herein. In some examples, aspects of the operations of 1210 may be performed by a signal manager 925 as described with reference to FIG. 9.

At 1215, the method may include selecting a first beamforming scheme or a second beamforming scheme based on a threshold, where the first beamforming scheme is selected if an angular separation satisfies the threshold or the second beamforming scheme is selected if an angular separation does not satisfy the threshold. The operations of 1215 may be performed in accordance with examples as disclosed herein. In some examples, aspects of the operations of 1215 may be performed by a beam manager 930 as described with reference to FIG. 9.

At 1220, the method may include communicating with the first UE, via a first beam from a first subarray of antennas, concurrently with the second UE via a second beam from a second subarray of antennas, where the first beam and the second beam are generated with the first beamforming scheme or the second beamforming scheme that is selected based on the angular separation between the first direction and the second direction, and where a first transmit power associated with the first beam is controlled, or a second power associated with the second beam is controlled, in accordance with a first power backoff scheme associated with the first beamforming scheme or in accordance with a second power backoff scheme associated with the second beamforming scheme. The operations of 1220 may be performed in accordance with examples as disclosed herein. In some examples, aspects of the operations of 1220 may be performed by a beam manager 930 as described with reference to FIG. 9.

The following provides an overview of aspects of the present disclosure:

Aspect 1: A method for wireless communications at a wireless device, comprising: receiving a first signal from a first UE, wherein the first signal is received from a first direction at the wireless device; receiving a second signal from a second UE, wherein the second signal is received from a second direction at the wireless device; and communicating with the first UE, via a first beam from a first subarray of antennas, concurrently with the second UE via a second beam from a second subarray of antennas, wherein the first beam and the second beam are generated with a first beamforming scheme or a second beamforming scheme that is selected based at least in part on an angular separation between the first direction and the second direction, and wherein a first transmit power associated with the first beam is controlled, or a second power associated with the second beam is controlled, in accordance with a first power backoff scheme associated with the first beamforming scheme or in accordance with a second power backoff scheme associated with the second beamforming scheme.

Aspect 2: The method of aspect 1, wherein the first beamforming scheme comprises DFT codebook-based beamforming or beamforming with beam weights with a progressive phase shift applied to the first subarray of antennas or the second subarray of antennas.

Aspect 3: The method of any of aspects 1 through 2, wherein the second beamforming scheme comprises zero-forcing beamforming or generalized inverse beamforming.

Aspect 4: The method of any of aspects 1 through 3, further comprising: selecting the first beamforming scheme or the second beamforming scheme based at least in part on a threshold, wherein the first beamforming scheme is selected if the angular separation satisfies the threshold or the second beamforming scheme is selected if the angular separation does not satisfy the threshold.

Aspect 5: The method of aspect 4, further comprising: receiving, from a network entity, configuration information indicating the threshold.

Aspect 6: The method of any of aspects 4 through 5, wherein the threshold is a function of a first size of the first subarray, a second size of the second subarray, or a combination thereof.

Aspect 7: The method of any of aspects 1 through 6, wherein at least one of the first subarray or the second subarray in the first beamforming scheme is respectively larger than at least one of the first subarray or the second subarray in the second beamforming scheme.

Aspect 8: The method of aspect 7, wherein the first power backoff scheme increases a degree of power backoff in association with an increased quantity of antennas of the first subarray or of the second subarray.

Aspect 9: The method of any of aspects 7 through 8, further comprising: transmitting a SSB via the first beam or the second beam; and receiving a signal indicating a characteristic of the SSB, wherein a degree of power backoff of the first power backoff scheme or of the second power backoff scheme is based at least in part on the characteristic of the SSB.

Aspect 10: The method of any of aspects 1 through 9, wherein the first UE is grouped in a first group of one or more UEs and the second UE is grouped in a second group of one or more UEs to satisfy an EIRP limit over an angular range from the wireless device.

Aspect 11: The method of aspect 10, wherein the first group of one or more UEs and the second group of one or more UEs are included in a multi-user multiple-input multiple-output (MU-MIMO) communication from the wireless device.

Aspect 12: A wireless device comprising one or more memories storing processor-executable code, and one or more processors coupled with the one or more memories and individually or collectively operable to execute the code to cause the wireless device to perform a method of any of aspects 1 through 11.

Aspect 13: A wireless device comprising at least one means for performing a method of any of aspects 1 through 11.

Aspect 14: A non-transitory computer-readable medium storing code the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive a first signal from a first user equipment (UE), wherein the first signal is received from a first direction at the wireless device;
receive a second signal from a second UE, wherein the second signal is received from a second direction at the wireless device; and
communicate with the first UE, via a first beam from a first subarray of antennas, concurrently with the second UE via a second beam from a second subarray of antennas, wherein the first beam and the second beam are generated with a first beamforming scheme or a second beamforming scheme that is selected based at least in part on an angular separation between the first direction and the second direction, and wherein a first transmit power associated with the first beam is controlled, or a second power associated with the second beam is controlled, in accordance with a first power backoff scheme associated with the first beamforming scheme or in accordance with a second power backoff scheme associated with the second beamforming scheme.

2. The wireless device of claim 1, wherein the first beamforming scheme comprises discrete Fourier transform (DFT) codebook-based beamforming or beamforming with beam weights with a progressive phase shift applied to the first subarray of antennas or the second subarray of antennas.

3. The wireless device of claim 1, wherein:
the second beamforming scheme comprises zero-forcing beamforming or generalized inverse beamforming.

4. The wireless device of claim 1, wherein the one or more processors are individually or collectively further operable to execute the code to cause the wireless device to:
select the first beamforming scheme or the second beamforming scheme based at least in part on a threshold, wherein the first beamforming scheme is selected if the angular separation satisfies the threshold or the second beamforming scheme is selected if the angular separation does not satisfy the threshold.

5. The wireless device of claim 4, wherein the one or more processors are individually or collectively further operable to execute the code to cause the wireless device to:
receive, from a network entity, configuration information indicating the threshold.

6. The wireless device of claim 4, wherein the threshold is a function of a first size of the first subarray, a second size of the second subarray, or a combination thereof.

7. The wireless device of claim 1, wherein at least one of the first subarray or the second subarray in the first beamforming scheme is respectively larger than at least one of the first subarray or the second subarray in the second beamforming scheme.

8. The wireless device of claim 7, wherein the first power backoff scheme increases a degree of power backoff in association with an increased quantity of antennas of the first subarray or of the second subarray.

9. The wireless device of claim 7, wherein the one or more processors are individually or collectively further operable to execute the code to cause the wireless device to:
transmit a synchronization signal block (SSB) via the first beam or the second beam; and
receive a signal indicating a characteristic of the SSB, wherein a degree of power backoff of the first power backoff scheme or of the second power backoff scheme is based at least in part on the characteristic of the SSB.

10. The wireless device of claim 1, wherein the first UE is grouped in a first group of one or more UEs and the second UE is grouped in a second group of one or more UEs to satisfy an effective isotropic radiated power (EIRP) limit over an angular range from the wireless device.

11. The wireless device of claim 10, wherein the first group of one or more UEs and the second group of one or more UEs are included in a multi-user multiple-input multiple-output (MU-MIMO) communication from the wireless device.

12. A method for wireless communications at a wireless device, comprising:
receiving a first signal from a first user equipment (UE), wherein the first signal is received from a first direction at the wireless device;
receiving a second signal from a second UE, wherein the second signal is received from a second direction at the wireless device; and
communicating with the first UE, via a first beam from a first subarray of antennas, concurrently with the second UE via a second beam from a second subarray of antennas, wherein the first beam and the second beam are generated with a first beamforming scheme or a second beamforming scheme that is selected based at least in part on an angular separation between the first direction and the second direction, and wherein a first transmit power associated with the first beam is controlled, or a second power associated with the second beam is controlled, in accordance with a first power backoff scheme associated with the first beamforming scheme or in accordance with a second power backoff scheme associated with the second beamforming scheme.

13. The method of claim 12, wherein the first beamforming scheme comprises discrete Fourier transform (DFT) codebook-based beamforming or beamforming with beam weights with a progressive phase shift applied to the first subarray of antennas or the second subarray of antennas.

14. The method of claim 12, wherein the second beamforming scheme comprises zero-forcing beamforming or generalized inverse beamforming.

15. The method of claim 12, further comprising:
selecting the first beamforming scheme or the second beamforming scheme based at least in part on a threshold, wherein the first beamforming scheme is selected if the angular separation satisfies the threshold or the second beamforming scheme is selected if the angular separation does not satisfy the threshold.

16. The method of claim 15, further comprising:
receiving, from a network entity, configuration information indicating the threshold.

17. The method of claim 15, wherein the threshold is a function of a first size of the first subarray, a second size of the second subarray, or a combination thereof.

18. The method of claim 12, wherein at least one of the first subarray or the second subarray in the first beamforming scheme is respectively larger than at least one of the first subarray or the second subarray in the second beamforming scheme.

19. The method of claim 18, wherein the first power backoff scheme increases a degree of power backoff in association with an increased quantity of antennas of the first subarray or of the second subarray.

20. A non-transitory computer-readable medium storing code, the code comprising instructions executable by one or more processors to:
receive a first signal from a first user equipment (UE), wherein the first signal is received from a first direction at a wireless device;
receive a second signal from a second UE, wherein the second signal is received from a second direction at the wireless device; and
communicate with the first UE, via a first beam from a first subarray of antennas, concurrently with the second UE via a second beam from a second subarray of antennas, wherein the first beam and the second beam are generated with a first beamforming scheme or a second beamforming scheme that is selected based at least in part on an angular separation between the first direction and the second direction, and wherein a first transmit power associated with the first beam is controlled, or a second power associated with the second beam is controlled, in accordance with a first power backoff scheme associated with the first beamforming scheme or in accordance with a second power backoff scheme associated with the second beamforming scheme.
